(19) United States
(12) Patent Application Publication
(10) Pub. No.: US 2004/0169395 A1
(43) Pub. Date: Sep. 2, 2004

(54) Door panel assembly

(76) Inventors: Dhansukh M. Chevli, Evansville, IN (US); Tim Ferguson, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/762,885

(22) Filed: Jan. 21, 2004

Related U.S. Application Data
(60) Provisional application No. 60/441,185, filed on Jan. 21, 2003.

(51) Int. Cl. B60J 5/00

(52) U.S. Cl. 296/146.5

(57) ABSTRACT

A composite inner door panel structure for a vehicle door, that is structurally sound, cost efficient, and easy to manufacture. The inner door panel structure generally includes a first panel, a second panel, and a conductive member adhesively disposed between the first panel and the second panel. Said first panel including an end portion, said second panel is configured in accordance with the configuration of the end portion of the first panel. The conductive member is preferably a steel wire or a one-piece construction made from rigid wire mesh of different types of metals including brass, bronze, stainless steel, copper and aluminum. The conductive member maintains spacing between the first panel and the second panel, and further provides a conductive material between the first and second panels for weldability in successive operations to complete the vehicle door.

### CROSS REFERENCES TO RELATED APPLICATIONS

U.S. Provisional Application for Patent No. 60/441,185, filed Jan. 21, 2003 with title “Door Panel Assembly” which is hereby incorporated by reference. Applicant claims priority pursuant to 35 U.S.C. Par. 119(e)(i).

### STATEMENT AS TO RIGHT TO INVENTIONS MADE UNDER FEDERALLY SPONSORED RESEARCH AND DEVELOPMENT

Not Applicable

### BACKGROUND OF THE INVENTION

1. Field of the Invention

The present invention relates generally to vehicle door panel construction and more particularly, the present invention relates to a composite inner door panel structure and method for making the same.

2. Brief Description of Prior Art

Automotive door panels are often constructed of the type where a combination of panels that include an inner door panel that is reinforced by welding a reinforcement panel to selected portions of the inner door panel. For example, a conventional inner door panel is stamped out of a large welded blank. The blank consists generally of two pieces of metal, a relatively thin piece of sheet metal laser welded to a thicker piece of sheet metal. The thicker piece ensures that the door assembly does not distort when hinged to the body of the vehicle. Laser welding is an expensive process. Further, these conventional door assemblies tend to be unnecessarily heavy and add significantly to the cost to the manufacture of the vehicle.

As will be seen from the subsequent description, the preferred embodiments of the present invention overcome shortcomings of the prior art.

### SUMMARY OF THE INVENTION

The present invention relates generally to a composite inner door panel structure, that is structurally sound, cost efficient, and easy to manufacture. The inner door panel structure generally includes a first panel, a second panel, and a conductive member adhesively disposed between the first panel and the second panel. The first panel including an end portion, the end portion including that section of the inner door panel that is hingedly attached to the body of the vehicle in successive operations to complete the vehicle door. The second panel is configured in accordance with the configuration of the end portion of the first panel. The conductive member is sandwiched between the first panel and second panel. The conductive member is preferably a one-piece construction made from steel wire or rigid wire mesh that can be selected from different types of metals including brass, bronze, stainless steel, copper, and aluminum. The second panel is attached to the inner side of the first panel, with the conductive member therebetween, using an epoxy structural adhesive. The conductive member maintains spacing between the first panel and the second panel, and further provides a conductive material between the first and second panels for weldability in successive operations. The panels can be welded together using conventional electrode welding.

### BRIEF DESCRIPTION OF THE DRAWINGS

FIG. 1 is an exploded perspective view of a preferred embodiment of the present invention, an inner door panel assembly.

FIG. 2 is a perspective view of the assembly of FIG. 1 formed into an inner door panel.

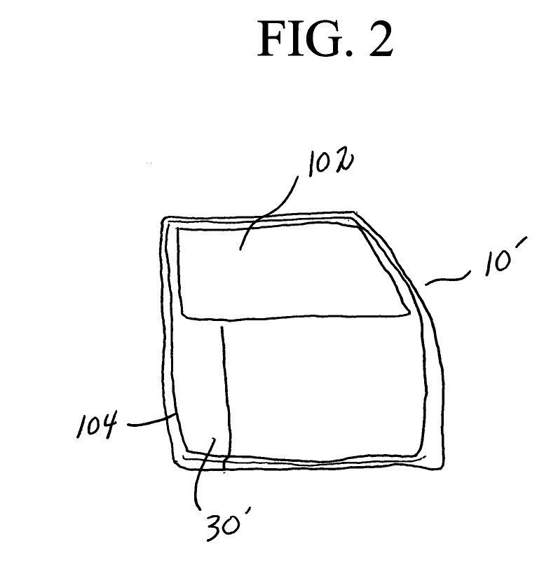

### DESCRIPTION OF THE PREFERRED EMBODIMENTS

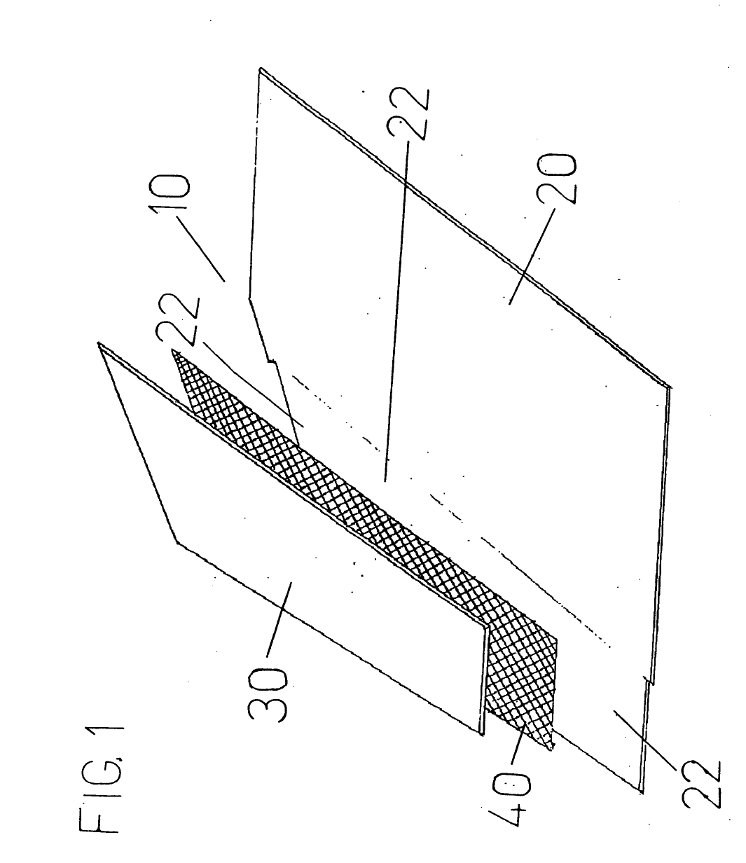

FIG. 1 illustrates a preferred embodiment of an inner door panel structure 10 made in accordance with the present invention, that is structurally sound, cost efficient, and easy to manufacture. Specifically, it will be noted in the drawing that the inner door panel structure of the present invention relates to a structurally sound inner door panel for a vehicle that eliminates the laser welding process used with conventional door panels. In the broadest context, the assembly consists of components configured and correlated with respect to each other so as to attain the desired objective.

The door panel structure 10 generally includes a first panel 20, a second panel 30, and a conductive member 40 adhesively disposed between the first panel 20 and the second panel 30. Not shown in the drawing is the door panel structure 10 in formed configuration for installation as an inner portion of the prior art door frame, the outer door panel, door hinges, and other mechanisms necessary to provide an operational vehicle door.

The first panel 20 formed of a single sheet of metal material, and is configured in accordance with the styling of the associated vehicle. The first panel 20 including an end portion 22, the end portion 22 being the load-bearing portion of the structure 10 that will be hinged to the body of the vehicle. In the preferred embodiment, the first panel 20 having a thickness of approximately 0.031″ however, other thickness' of metal will achieve the objective of the present invention.

The second panel 30 formed of a single sheet of metal and in the preferred embodiment, is contoured in accordance with the configuration of the end portion 22 of the first panel 20. In application, the second panel 30 is adhesively attached to the end portion 22 of the first panel 20 to improve the strength of the structure 10 creating a composite structure that is structurally sound.

In the preferred embodiment, the second panel 30 having a thickness of approximately 0.023″ however, other thickness' of metal will achieve the objective of the present invention. As shown in the drawings the first panel 20 and the second panel 30 having a generally trapezium configuration.

The conductive member 40 is sandwiched between the first panel 20 and the second panel 30. According to a preferred embodiment of the present invention, the conductive member 40 is a steel wire or can be made from different metals that can be selected from metals including brass, bronze, stainless steel, copper, and aluminum. However, as shown in the drawings, the conductive member 40 may be a one-piece construction made from rigid wire of any of the different types of metals.

The second panel 30 is attached to the inner side of the first panel 20, with the conductive member 40 therebetween, using an epoxy structural adhesive. The adhesive is known in the art, and generally has two requirements:

1) the bond strength should be strong enough to withstand the metal stamping operation; and

2) the composite structure must be weldable in successive operations.

The adhesive can be electronically conductive and allows the first panel 20 to be bonded to both the second panel 30 and the conductive member 40. The various methods of adhesively joining the panels 20, 30 and conductive member 40 according to the teachings of the present invention are known in the art.

In the preferred embodiment the thickness of the conductive member 40 is approximately 0.010″ steel wire. The wire mesh is preferably composed of approximately 0.010″ wire having a 40 mesh weave. The conductive member 40 maintains spacing between the first panel 20 and the second panel 30. Further, the conductive member 40 provides a conductive material between the panels 20, 30 for conventional weldability in successive operations to complete the manufacture of the vehicle door.

In the event the door panel structure 10 yields a thickness that is too thick or thin, the thickness of the conductive member 40 may be adjusted to maintain the desired thickness. As such, the conductive member 40 may vary in thickness to achieve the desired objective.

When the conductive member 40 is the wire mesh, such wire mesh is preferably configured in accordance with the configuration of the end portion 22 and the second panel 30 so that a single piece of the wire mesh will overlay that area defining the end portion 22 of the first panel 20. In an alternate embodiment, a plurality of spaced apart wire mesh patches can be selectively located between the first panel 20 and the second panel 30. Patches can be located at points where a later weld is to be applied.

The first and second panels 20, 30 thus attached to each other with the conductive member 40 therebetween, forming the door panel structure 10. The structure 10 can now be formed for installation as an inner portion of the prior art car door frame.

The composite structure of the present invention is of a high strength construction and replaces the thicker welded blanks of the conventional inner door panel, which results in a desirable weight reduction for the door panel structure 10. The present structure further avoids the expensive process of laser welding as discussed above and therefore will reduce significantly the cost of manufacturing the vehicle. The result is a composite door panel 10 that has greater strength in the area of greatest stress where the door will be hinged and yet that minimizes the weight of the door panel.

In operation the adhesive can be applied to any of the panels 20 or 30 or the mesh 40. The mesh 40 can then be positioned on one of the panels 20 or 30 and the other panel placed to form a composite panel 10 as shown in FIG. 1. The adhesive will then hold the entire composite panel together as subsequent operations such as forming or blank and pierce are performed on the panel 10. Once the panel 10 has been completed, the panel 10 can then be welded by conventional means. Without the mesh 40, expensive laser welding would be required to finish the panel.

Although the description above contains many specificities, these should not be construed as limiting the scope of the invention but as merely providing illustrations of some of the presently preferred embodiments of this invention. For example, as the conductive member 40, a suitable conductive adhesive may be used in place of the steel wire or wire mesh however, as should be understood, applying a steel wire or wire mesh is less expensive to obtain the desired objective as discussed above.

Thus the scope of the invention should be determined by the appended claims in the formal application and their legal equivalents, rather than by the examples given.

I claim:

1. A composite inner door panel structure comprising:
a first panel having a end portion,
a second panel adhesively attached to the end portion of the first panel, and
a conductive member disposed between the first panel and the second panel.

2. The inner door panel as recited in claim 1, wherein the configuration of the second panel is similar to the configuration of the end portion.

3. The inner door panel structure as recited in claim 1, wherein the conductive member is a steel wire.

4. The inner door panel structure as recited in claim 1, wherein the conductive member is a rigid wire mesh.

5. The inner door panel structure as recited in claim 1, wherein the conductive member includes a conductive adhesive.

6. The inner door panel structure as recited in claim 1, wherein the conductive member selected from the group consisting of brass, bronze, stainless steel, copper and aluminum.

7. A composite structure comprising:
a first panel,
a second panel adhesively attached to the first panel, and
a conductive member disposed between the first panel and the second panel.

8. The composite structure as recited in claim 7, wherein the conductive member is a steel wire.

9. The composite structure as recited in claim 7, wherein the conductive member is a rigid wire mesh.

10. The composite structure as recited in claim 7, wherein the conductive member is a conductive adhesive.

11. The composite structure as recited in claim 7, wherein the conductive member selected from the group consisting of brass, bronze, stainless steel, copper, and aluminum.

12. A method of forming a composite structure comprising:
positioning a conductive member between a first panel and a second panel,
attaching the first panel to the second panel, and
wherein the first panel is attached to the second panel with an adhesive.

13. The method of claim 12, wherein the conductive member is wire mesh.

14. The method of claim 13, wherein the step of attaching is followed by a step of welding said first panel to said second panel.

15. The method of claim 13, wherein the step of attaching is followed by a step of forming the composite panel into an inner door panel.

16. The method of claim 15, wherein the step of forming the composite panel into an inner door panel is followed by the step of welding said first panel to said second panel.
